(19) United States
(12) Patent Application Publication
(10) Pub. No.: US 2021/0323318 A1
(43) Pub. Date: Oct. 21, 2021

(54) PRINT DRYING

(71) Applicant: HEWLETT-PACKARD DEVELOPMENT COMPANY, L.P., Spring, TX (US)

(72) Inventors: Lorraine T. Golob, Columbia Center, Suite 210, WA (US); Steve Rohman, Vancouver, WA (US); Matt Raisanen, Vancouver, WA (US); Kevin Lo, Vancouver, WA (US)

(21) Appl. No.: 16/605,093

(22) PCT Filed: Jun. 12, 2018
(86) PCT No.: PCT/US2018/037087

§ 371 Date: Oct. 14, 2019

(51) Int. Cl. B41J 11/00; B41J 2/045

(52) U.S. Cl. CPC B41J 11/002; B41J 2/04566; B41J 2/04553; B41J 2/04508

(57) ABSTRACT

Some examples include a print system including a memory to store instructions and print data of a print job, a processor to execute the instructions in the memory to reference the print data of the print job, determine a process characteristic of a print job, the process characteristic including one of a plexity of the print job, a finishing of the print job, or a humidity of the print environment, and transform the process characteristic into a print process modifier. The print system including a print engine including a print path to move the medium along to deposit a print substance onto a medium based on the print data and apply drying to the medium, and a controller operably coupled to the processor and the print engine, the controller to adjust the drying of the medium along the print path of the print engine based on the print process modifier.

### BACKGROUND

Imaging systems, such as printers, copiers, etc., may be used to form markings on a physical medium, such as text, images, etc. An imaging system can perform two-dimensional or three-dimensional printing operations. In some examples, imaging systems may form markings on the physical medium by performing a print job. A print job can include forming markings such as text and/or images by transferring a print substance (e.g., ink, toner, etc.) to the physical medium. Imaging device, such as printers, include a print path where printing operations are performed.

### BRIEF DESCRIPTION OF THE DRAWINGS

FIG. 1 is a block diagram of an example imaging system in accordance with aspects of the present disclosure.

FIG. 2 is a block diagram of an example imaging system in accordance with aspects of the present disclosure.

FIG. 3 is a block diagram of an example non-transitory computer-readable storage medium useful in an imaging system in accordance with aspects of the present disclosure.

FIG. 4 is a flow chart of an example method of regulating a print process of an imaging system in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In general, imaging devices can create physical representations, patterns, or images by depositing a print substance on a print medium in a desired pattern. Imaging devices can deposit the print substance onto the physical medium during an imaging or printing process. In some examples, imaging devices deposit quantities of the print substance onto the printable medium based on job attributes of a print job. A job attribute represents a characteristic of a print job. Some example job attributes include print settings, user interface (UI) settings, a print substance type, a media type, a page size, a page orientation, a content class, a number of pages, a number of copies, a simplex or duplex job option, a grayscale or color option, a stapling option, a hole punching option, a booklet making option, and the like.

The imaging device can include any hardware device with functionalities to physically produce representation(s) (e.g., text, images, models, etc.) on the medium. The medium can include various types of print media, such as paper, photopolymers, plastics, composite, and can include any suitable object or materials to which a print substance from a printing device can be applied including materials such as powdered build materials for forming three-dimensional articles. Print substances such as printing agents, marking agents, and colorants, can include toner, liquid inks, or other suitable marking materials that may or may not be mixed with fusing agents, detailing agents, or other materials and can be applied to the medium. In some examples, the imaging devices, such as inkjet printers, deposit a liquid print substance that is ejectable from a print head, such as ink, toner, binding agent, or the like. Many liquid print substances (e.g., inks) are water-based.

Depending on the quantity of the printing substance deposited, a medium that is subject to a quantity of print substance to make the medium “wet” can move through the print path differently than medium that is subject to a lesser quantity of print substance. The effect of the print substance on the medium can be influenced by the print substance density in an area, the location of the dispensed print substance on the medium, the size of the area of the dispensed print substance on the medium and the type of medium, humidity and temperature of the print environment, for example. In some examples, a number of physical properties of the printable medium can be changed when the printing substance deposited by the imaging device are not completely dry. In some examples, a liquid state of printing substance can cause distorted properties in the medium. For example, wetting print media with large quantities of print substance can cause the media to swell, distort, buckle, and/or curl. Partially dried printed media can have distorted properties such as curl, cockle, reduction in stiffness, increased surface roughness, extruded surface fibers, misaligned fibers, and increased sheet to sheet friction of the media. Printed media that is not completely dry can provide difficulties when stacking and/or aligning for finishing operations such as stapling or hole punching.

Appropriate print processing, including appropriate dry time and/or dry temperature can be beneficial to maintain media stiffness and to reduce medium-to-medium friction in order to improve reliability in handling and finishing with, for example. In some examples, the imaging system can determine and set dry time (e.g., time it takes to print one page or delay before beginning to print next page) depending on the print content, environmental conditions, plexity, and finishing of the media. Plexity, as used herein, is the dispensing of print substance on one side (i.e., simplex) of the medium or printing on both sides (i.e., duplex) of the medium. Generally, dry time is the time that ink on a media has to substantially dry in order that any later manipulations will not cause image quality defects (e.g., ink smears) or finishing defects (e.g., unaligned stapled pages) in the finished print job. Similarly, the imaging system can determine and set dry temperature and pressure applied to the media along the print path depending on the print content, environmental conditions, plexity, and finishing of the media.

In some examples, lowering, or decreasing, a speed of the media along a print path of the imaging system can allow for additional dry time to more fully, or completely, dry the printed media and provide printed media that is easier to compile or otherwise manipulate. Modifying the print process speed along the print path modifies the dry time by exposing the media to drying mechanisms for longer periods of time when the print speed is decreased, for example. In other examples, drying of the printed media can be adjusted by increasing the printer's dryer temperature, increasing a fan speed, or increasing a heated pressure roller temperature. In some examples, more than one of the adjustments to the print process can be used to increase drying of the printed media. High humidity print environments, printing on opposing surfaces of the medium (e.g., duplexity), and large regions of print substance can increase the print substance level on the medium and additional drying of the printed media can be useful to improve output stacking and alignment for finishing operations.

The technique of the present disclosure can be used to adjust the print drying process before the print fluid is dispensed onto the medium based on the print data of a print job, environmental characteristics, and user selected characteristics. Adjustments to the print drying can be determined to selectively increase print drying parameters, prior to printing on the media. The print drying process, regulation, and management can be performed on a page-by-page or on a print job basis. In accordance with aspects of the present disclosure, selectively print drying processing can improve output characteristics of the printed medium such as enhanced sheet flatness for improved reliability in handling the output medium and improved ability to neatly stack the media for improved aligned stapled finished media. Further, the media stiffness can be maintained and medium-to-medium friction can be reduced to improve reliability in handling and finishing.

In some examples, the selectively adjusted print drying process can include adjustments to the print process speed including at the conditioner, at the finisher, or at any or all portions of the print path. By selectively decreasing a print speed on print jobs or media pages with select print condition parameters, an overall maximized print speed can be realized for maximizing throughput images per second (ips) or images per minute (ipm) of the imaging system. In one example, a decreased transport speed of the medium past a dryer, for example, can allow for more drying of the printed medium due to a longer dwell time of the medium in the conditioner or drying assembly. In other examples, drying of the printed medium can be adjusted by increasing the printer's dryer temperature, increasing a fan speed, or increasing a heated pressure roller temperature. In some examples, more than one of the adjustments to the print process can be used to selectively increase drying of the printed media.

Numerous variables ultimately affect the drying of a medium such as area coverage of the print substance, mass of the print substance, thickness of the medium, composition of the medium, print substance composition, for example. One or several of the numerous variables can be included in determinations of the print drying. For example, the density or mass distribution of the print substance to be deposited on the medium can be mapped and transformed into weighted values representing the print substance to be dispensed across the medium in order to selectively increase drying time of the medium. In some examples, the examples of the present disclosure can be used as an extension of, or added to, the weighted values representing the print substance used by the imaging system to further selectively adjust drying of the media. The examples of the present disclosure can further selectively increase drying of the media in the imaging system based on determinations of variables related to print environmental conditions, plexity, and finishing of the media.

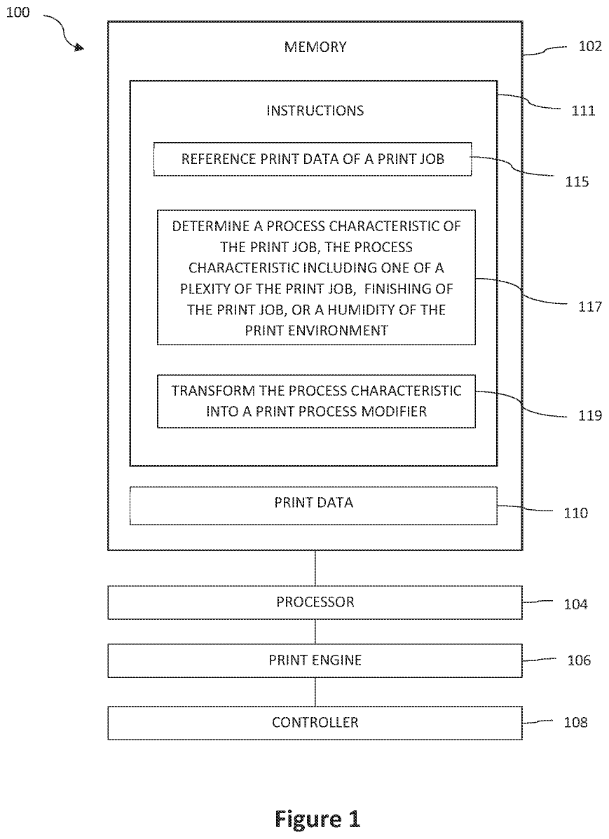

FIG. 1 is a block diagram of an imaging system 100 in accordance with aspects of the present disclosure. In one example, the imaging system 100 is an inkjet printing system or other suitable printing system that generates printed media to be dried. The imaging system 100 includes a memory 102, a processor 104, a controller 106, and a print engine 108. The memory 102 can store instructions 111 and print content, or print data, 110 of a print job. The memory 102 can store data, programs, instructions, or any other machine readable data that can be utilized to operate the imaging system 100. The memory 102 can store computer executable instructions. The instructions 111 can include a set of instructions 115-119 (e.g., such as may be fetched and/or executed by processor 104). Instruction 115 is to reference print data 110 of a print job. Instruction 117 is to determine a process characteristic of the print job, the process characteristic including one of a plexity of the print job, a finishing of the print job, or a humidity of the print environment. Instruction 119 is to transform the process characteristic into a print process modifier.

The processor 104 can access the memory 102 and execute the computer executable instructions (e.g., instructions 115-119). The processor 104 can be a computing device and can include an application-specific integrated circuit (ASIC), among other things. The processor 104 can execute a set of instructions to implement the operations of the examples included herein. The controller 106 can include a combination of hardware and programming. The controller 106 is operably coupled to the print engine 108 to control operations of the print process. For example, the controller 106 can receive signals, such as electrical, optical, or mechanical signals, representative of a digital image to be transformed in a printed medium image. The controller 106 can be operably coupled the processor 104 and the memory 102 to set print parameters of the print engine 108 based on the print content of the image to be printed. The print engine 108 includes mechanisms and logic to print or mark images on media.

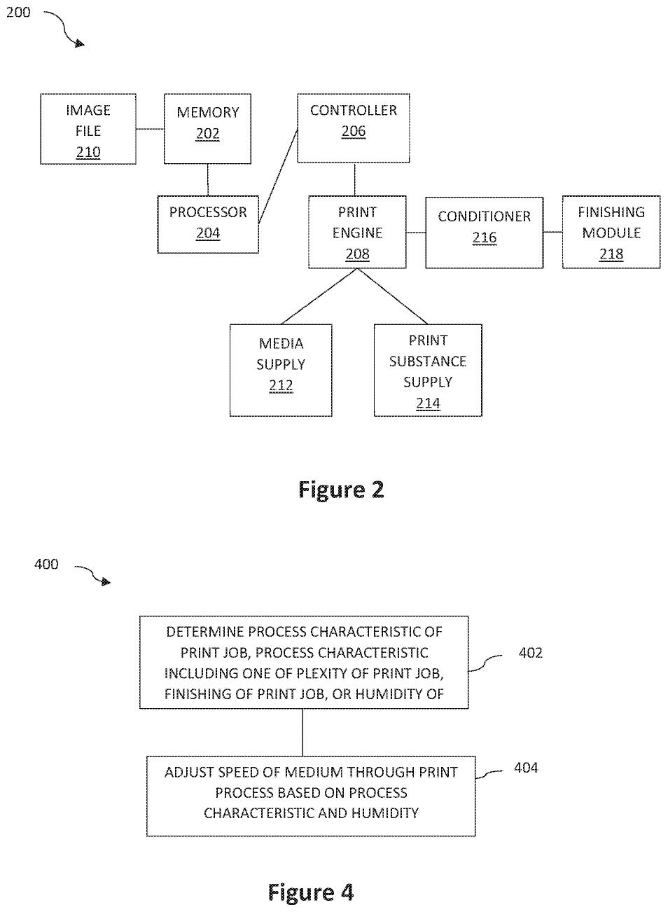

FIG. 2 is a block diagram of another example imaging system 200 in accordance with aspects of the present disclosure. Aspects of the imaging system 200 are similar to those of imaging system 100 described above. The imaging system 200 can include a memory 202, a processor 204, a controller 206, and a print engine 208. The imaging system 200 can receive an image file 210 including digital print content data of a print job. A media supply 212 can provide a selected medium to the print engine 208 on which the images (based print data of the image file 210) can be printed or marked. The print engine 208 is coupled to a consumable print substance supply 214 containing print substance that can be used to print or mark the medium based on the received print data. An example of the print engine 208 can include an inkjet print engine that can apply a liquid print substance. The print engine 208 can deliver the print substance to the medium via a print head proximate to the medium. The printed media can be fed, or moved along a print path (not shown), for example, through the print engine 208 and a conditioner 216, including and drying mechanism such as fans, heated pressure rollers, calendar rollers, etc. The print path can terminate at a finishing module 218 that can be included with the imaging system 200. In one example, the finishing module 218 is an external finishing module that is coupled to the print engine 208 and the conditioner 216. The finishing module 218 can cut, collate, stack, staple, or otherwise provide the printed media in a finished form.

Selectively increasing drying of the media in the imaging system can be based on determinations of process characteristics related to a specific print job including print environmental conditions, plexity, and finishing of the media. Environmental process characteristics can include humidity of a print environment, for example. Temperatures of the print environment can also be an environmental process characteristic. Sensors can be included in the imaging device (e.g., inkjet printing device) to sense, or determine, environmental conditions such as temperatures and humidity and transmit the sensed data of the environmental conditions to the processor. In one example, the sensed humidity can be determined to be of categorical range as high, medium, low humidity. In one example, a relatively “high” humidity can be greater than 65%, “medium” humidity can be between 65% and 15%, and “low” humidity can be less than 15%. Other categorization and ranges of humidity are also acceptable. A high humidity print environment can cause the printed medium to be “wetter”, or dry more slowly than a low humidity print environment. The humidity, or other environmental process characteristic, can be determined and processed as appropriate to determine an appropriate adjustment to the drying process of the print medium. For example, it can be useful to decrease the print process speed of the printed medium in a relatively high humidity print environment in order to increase drying time.

The plexity of a print job can also be a print characteristic that is useful in determining appropriate print drying for the printed medium. For example, a print job configured as a duplex includes print substance on both sides of a medium whereas a simplex print job includes print substance on only one side of the medium. The same print job printed as a duplex instead of a simplex, includes more print substance on a single medium than the same print job distributing the print substance to a single side of two mediums. Increased print substance in a medium increases the print density and the “wetness” of the printed medium. With the increased print density of the print substance on the medium for a duplex processed print job (vs. simplex), additional drying can be desirable to improve finishing operations. The selection of plexity, more specifically, the selection of duplex or simplex printed, can be input, such as by a user, into the imaging system.

Another process characteristic that can be useful in determinations of adjustments to the print drying process are finishing process characteristics of a print job. In one example, the finishing of the print job can be selected by a user. For example, whether the print job is to be stapled or unstapled is a finishing process characteristic that is input selected by the user. In another example, hole punching of the medium is a finishing process characteristic that is input selected by the user.

One or more of the determined process characteristics can be transformed into a print process modifier to appropriately adjust print drying process of the print medium. For example, one or more of the process characteristics is determined and processed by the processor based on instructions and a look-up table stored in the memory of the imaging system. The look-up table process characteristics (e.g., humidity, plexity, finishing operations) and convert, or transform, the process characteristics into a print process modifier used to by the controller to adjust the print drying (e.g., process speed) of the print medium. In one example, the process speed of a duplex, stapled printed media in a high humidity environment is reduced from 4 images per second (ips) to 2 ips based on the print process modifier. Numerous other print speed reductions and speeds are also available and the example provided is by no way limiting.

The operations of the imaging device can be adjusted based on process characteristics such as environmental conditions and user criteria to increase drying of printed media, as discussed above. In some examples, the operations of the imaging device can also be adjusted based on a print content score. The print content score can be determined based on print content, or print job data, including the print density and amount of the print substance to be deposited on the medium during a print job, for example. The print operations can be adjusted to address the density of the print substance application onto regions of the medium. The print process can proceed along the print path at a speed appropriate to permit the print substance to dry prior to output of the medium to a finisher, for example. Adjustments to the operations can be selectively made on a page by page, or sheet by sheet, basis based on the print content score in order to add drying time to printed medium to which additional drying time would be useful to improve finished attributes of the printed medium.

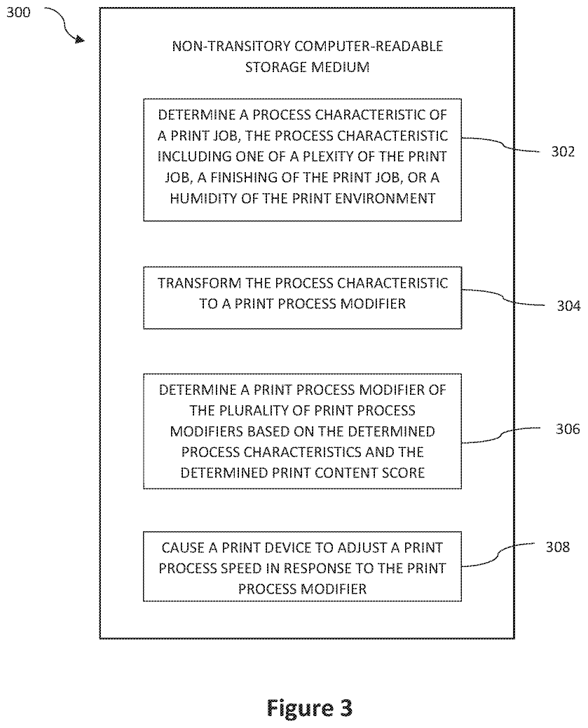

FIG. 3 is a block diagram of a non-transitory computer-readable storage medium in accordance with aspects of the present disclosure. In one example, the non-transitory computer-readable storage medium 300 is included in the memory of the imaging system and includes a set of instructions 302-308 executable by the processor. Instruction 302 is to determine a process characteristic of a print job, the process characteristic including one of a plexity of the print job, a finishing of the print job, or a humidity of the print environment. Instruction 304 is to transform the process characteristic to a print process modifier. Instruction 306 is to determine a print process modifier of the plurality of print process modifiers based on the determined process characteristics and the determined print content score. Instruction 308 is to cause a print device to adjust a drying process in response to the print process modifier.

FIG. 4 is a flow chart of an example method 400 of regulating a print process in accordance with aspects of the present disclosure. At 402, a process characteristic of a print job is determined, the process characteristic including one of a plexity of the print job, a finishing of the print job, or a humidity of the print environment. Determining the process characteristic can include determining both of the plexity of the print job and the finishing of the print job. Determining the humidity can include sensing the print environment via a sensor. At 404, a drying process of a medium is adjusted based on the process characteristic. Adjusting the drying process can include referencing a look-up table. The process characteristic can include print substance density.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A print system, comprising:
a memory to store instructions and print data of a print job;
a processor to execute the instructions in the memory to:
reference the stored print data of the print job,
determine a process characteristic of the print job, the process characteristic including one of a plexity of the print job, a finishing of the print job, or a humidity of the print environment, and
transform the process characteristic into a print process modifier; and
a print engine including a print path, the print engine to move the medium along the print path to deposit a print substance onto a medium based on the print data and apply drying to the medium; and
a controller operably coupled to the processor and the print engine, the controller to adjust the drying of the medium along the print path of the print engine based on the print process modifier.

2. The system of claim 1, wherein the processor to execute the instructions in the memory to:
determine a print content score representative of a quantity of the print substance to be dispensed on the medium based on the print data,
reference a look-up table including a plurality of print process modifiers associated with a plurality of print content scores, and
determine the print process modifier based on the determined print content score.

3. The system of claim 1, wherein the controller is to adjust the speed of the medium along the print path based on the print process modifier.

4. The system of claim 1, wherein the finishing of the print job includes one of stapled or unstapled printed media.

5. The system of claim 1, wherein the plexity is based on a user input of plexity.

6. A non-transitory computer-readable storage medium comprising a set of instructions executable by a processor resource to:
determine a process characteristic of a print job, the process characteristic including one of a plexity of the print job, a finishing of the print job, or a humidity of the print environment;
transform the process characteristic to a print process modifier;
determine a print process modifier of the plurality of print process modifiers based on the determined process characteristics and a print content score; and
cause a print device to adjust a drying process in response to the print process modifier.

7. The non-transitory computer-readable storage medium of claim 6, wherein the print device is an inkjet printing device.

8. The non-transitory computer-readable storage medium of claim 6, wherein to cause the print device to adjust the drying process includes instructions executable by the processor resource to cause selective decrease of a print process speed in response to the print process modifier.

9. A method of managing a print process, comprising:
determining a process characteristics of a print job, the process characteristics including one of a plexity of the print job, a finishing of the print job, or a humidity of the print environment; and
adjusting a drying process of a medium based on the process characteristics.

10. The method of claim 9, comprising:
transforming the process characteristic to a print process modifier.

11. The method of claim 9, wherein adjusting the drying process includes referencing a look-up table.

12. The method of claim 9, wherein the process characteristics include print substance density.

13. The method of claim 9, wherein determining the process characteristics include determining both of the plexity of the print job and the finishing of the print job.

14. The method of claim 9, wherein determining the humidity includes sensing the print environment via a sensor.

15. The method of claim 9, the determining the process characteristic is based on a user input of one of the plexity of the print job or the finishing of the print job.
